(19) United States
(12) Patent Application Publication
(10) Pub. No.: US 2025/0215158 A1
(43) Pub. Date: Jul. 3, 2025

(54) Cross-linkable compositions on the basis of organosilicon compounds

(71) Applicant: WACKER CHEMIE AG, Munich (DE)

(72) Inventors: Stephan Rensing, Meißen (DE); Stephan Marrack, Weinböhla (DE); Peter Schöley, Diera-Zehren (DE); Zhou Zhou, Meißen (DE)

(73) Assignee: WACKER CHEMIE AG, Munich (DE)

(21) Appl. No.: 18/849,549

(22) PCT Filed: Mar. 28, 2022
(86) PCT No.: PCT/EP2022/058166

§ 371 Date: Sep. 23, 2024

(51) Int. Cl. C08G 77/26; C08G 77/06; C08G 77/16; C08G 77/18; C08G 77/20

(52) U.S. Cl. CPC C08G 77/26; C08G 77/06; C08G 77/16; C08G 77/18; C08G 77/20

(57) ABSTRACT

A crosslinkable composition along with processes for producing and uses for the same. The crosslinkable composition is obtained by a condensation reaction of (A) organosilicon compounds having at least two OH groups, (B) heterocyclic compounds of the formula (I)

A[CR¹₂SiRₐ(OR²)₃₋ₐ]ₓ (I), and

(C) at least one compound containing units of the formulae

Si(OR⁴)₃O_{1/2} (III),

Si(OR⁴)₂O_{2/2} (IV),

(OR⁴)SiO_{3/2} (V), and

optionally SiO_{4/2} (VI).

Where the compound (C) contains at least 10 mol % of units of the formula (V).

The invention relates to crosslinkable compositions based on organosilicon compounds that cure with elimination of alcohols to give materials having very high stability, to processes for production thereof and to the use thereof.

Single-component sealing compounds that are storable with exclusion of water and cure on ingress of water at room temperature with elimination of alcohols to give elastomers are already known. These products are used in large volumes, for example in the construction industry. These mixtures are based on polymers terminated by silyl groups bearing reactive substituents, such as OH groups or hydrolyzable groups, for example alkoxy groups. In addition, these sealing compounds may contain fillers, plasticizers, crosslinkers, catalysts and various additives.

Catalysts used are often diorganotin compounds. Titanium compounds are also used in some cases. But titanium catalysts lead very quickly to undesirable yellowing and are therefore not preferred.

From the point of view of chemical legislation, however, the preferred organotin compounds are the subject of ever more critical classification. Attempts have therefore been made to use substances such as dioctyltin and dibutyltin compounds in a smaller amount or even no longer at all in RTV1 sealing compounds.

EP 2 176 351 B1 teaches the production of RTV1 sealing compounds based on 4-(triethoxysilylmethyl)tetrahydro-1,4-oxazine. The examples adduced show that it is also possible to dispense entirely with the use of organotin catalysts. In that case, however, the processing time in the case of the firm variants is too long for use as join sealant.

EP 2 855 591 B1 describes the addition of hydrolyzates formed from unsubstituted alkyltrialkoxysilanes to give RTV1 sealing compounds based on 4-(triethoxysilylmethyl)tetrahydro-1,4-oxazine. These specific siloxanes improve the resistance of the cured compositions to the action of warm and moist environmental conditions. The compositions contain dialkyltin compounds as catalyst.

EP 3 433 321 B1 describes the production of mobile RTV1 coating compositions based on N,N-dialkylaminomethyltrialkoxysilanes. As well as other constituents, the mixtures also contain a partial hydrolyzate formed from tetraethoxysilane. The composition here is chosen such that the cured mass has good adhesion to various substrates. Because of the high reactivity of the alpha-silanes selected, no further catalysts or curing accelerators are needed.

It has been found that, surprisingly, RTV1 sealing compounds based on 4-(triethoxysilylmethyl)tetrahydro-1,4-oxazine, even without additions of organotin catalysts, have very good curing characteristics when the compositions contain partial hydrolyzates of tetraalkoxysilanes. Because of the comparatively low reactivity of the partial hydrolyzates, for example, the person skilled in the art could not expect the skin time of an RTV1 sealing compound based on an alpha-silane to be able to be shortened in a controlled manner.

It was particularly surprising here that the cured materials have low tensile stress values under strain. Furthermore, it was very particularly surprising that the cured materials have low tensile stress values under strain when only small amounts of plasticizers are used.

The invention provides compositions crosslinkable by condensation reaction and producible using
(A) organosilicon compounds having at least two OH groups,
(B) heterocyclic compounds of the formula

A[CR¹₂SiRₐ(OR²)₃₋ₐ]ₓ (I),
where
A represents a radical based on a heterocycle AHₓ and containing at least one ring-forming element of main group 3 and/or 5, in which x hydrogen atoms are replaced by chemical bonds to the CR¹₂ radical, where at least one of these bonds is present on a ring-forming element of main group 3 or 5,
R denotes identical or different, monovalent, optionally substituted hydrocarbyl radicals,
R¹ may be the same or different and denotes a hydrogen atom or monovalent, optionally substituted hydrocarbyl radicals,
R² may be the same or different and denotes monovalent, optionally substituted hydrocarbyl radicals,
a=0 or 1, preferably 0, and
x=1, 2 or 3, preferably 1 or 2, more preferably 1,
and/or partial hydrolyzates thereof
and
(C) at least one compound containing units of the formulae

Si(OR⁴)₃O_{1/2} (III),

Si(OR⁴)₂O_{2/2} (IV),

(OR⁴)SiO_{3/2} (V) and
optionally

SiO_{4/2} (VI),
where
R⁴ may be the same or different and is in each case independently an alkyl radical,
with the proviso that compound (C) contains at least 10 mol % of units of the formula (V).

The partial hydrolyzates of the compounds of the formula (I) may be partial homohydrolyzates or partial cohydrolyzates. If component (B) used in accordance with the invention comprises partial hydrolyzates of the compounds of the formula (I), preference is given to those having up to 10 silicon atoms.

Radical R is preferably optionally substituted, monovalent hydrocarbyl radicals having 1 to 18 carbon atoms, more preferably alkyl radicals, the vinyl radical, the 3,3,3-trifluoroprop-1-yl radical and the phenyl radical, especially the methyl radical.

Examples of radicals R are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; hexyl radicals, such as the n-hexyl radical; heptyl radicals, such as the n-heptyl radical; octyl radicals, such as the n-octyl radical and iso-octyl radicals, such as the 2,2,4-trimethylpentyl radical; nonyl radicals, such as the n-nonyl radical; decyl radicals, such as the n-decyl radical; dodecyl radicals, such as the n-dodecyl radical; octadecyl radicals, such as the n-octadecyl radical; cycloalkyl radicals, such as the cyclopentyl, cyclohexyl, cycloheptyl radical and methylcyclohexyl radicals; alkenyl radicals, such as the vinyl, 1-propenyl and 2-propenyl radicals; aryl radicals, such as the phenyl, naphthyl, anthryl and phenanthryl radical; alkaryl radicals, such as o-, m-, p-tolyl radicals; xylyl radicals and ethylphenyl radicals; and aralkyl radicals, such as the benzyl radical and the α- and β-phenylethyl radical.

Examples of substituted radicals R are haloalkyl radicals, such as the 3,3,3-trifluoroprop-1-yl radical, the 1,1,1,3,3,3-hexafluoroprop-2-yl radical and the heptafluoroprop-2-yl radical, haloaryl radicals, such as the o-, m- and p-chlorophenyl radical, and the 2-methoxyethyl radical, the 2-methoxyprop-1-yl radical and the 2-(2-methoxyethoxy)ethyl radical.

Examples of radicals R¹ are the hydrogen atom and the radicals specified for R.

Radical R¹ is preferably a hydrogen atom and hydrocarbyl radicals having 1 to 20 carbon atoms, especially a hydrogen atom.

Examples of radicals R² are the radicals specified for R.

Radical R² is preferably alkyl radicals having 1 to 6 carbon atoms, more preferably the methyl and ethyl radical, especially the ethyl radical.

Radical A is cyclic compounds having ring-forming atoms of at least two different elements, with the proviso that at least one ring-forming atom is an element of main group 3 and/or 5 that has a binding site to the carbon atom of the —CR¹₂— radical in formula (I).

Radical A is preferably cyclic organic compounds, the ring structures of which, as well as carbon atoms, also contain at least one element of main group 3 and/or 5 and more preferably at least one further heteroatom.

The term “heteroatoms” shall be understood hereinafter to mean all ring-forming atoms apart from carbon.

The ring-forming heteroatoms in radical A are preferably nitrogen, phosphorus, oxygen, silicon and sulfur, more preferably nitrogen and oxygen.

Radical A may also be optionally substituted, saturated or partially unsaturated heterocycles. If the ring A is substituted, the substituents are preferably halogen atoms, hydrocarbyl radicals and organyloxy radicals, where these substituents may be polyvalent radicals that may be bonded to one or more ring-forming atoms.

Radical A may also contain ring carbon atoms having oxygen or sulfur atoms bonded via a double bond, with the proviso that such ring carbon atoms do not have any direct bond to a ring-forming heteroatom of main group 3 or 5 bonded to a CR¹₂ radical of the formula (I).

Radical A may also include ring carbon atoms with nitrogen or phosphorus atoms bonded via a double bond, but this is not preferred.

Radical A is preferably 3-, 4-, 5-, 6-, 7- or 8-membered heterocycles having, as ring-forming atoms in addition to carbon, nitrogen and/or phosphorus and/or oxygen and/or sulfur as heteroatom, with the proviso that at least one ring-forming atom is an element of main group 3 and/or 5, where further rings may also be joined by fusion.

More preferably, the heterocycles on which the A radicals are based are 5- and 6-membered heterocycles which contain a further ring heteroatom as well as the heteroatom of main group 3 and/or 5 which is required for binding to the CR¹₂ radical of the compounds of the formula (I).

Examples of heterocycles on which the A radicals are based are aziridine, azetidine, pyrrole, pyrrolidine, 1,3-oxazolidine, 1,3-thiazolidine, 1H-1,2-diazole, Δ²-1,2-diazoline, Δ⁴-1,2-diazoline, 1,3-diazole, Δ²-1,3-diazoline, Δ⁴-1,3-diazoline, 1,3-diazolidine, 1,2,3-triazole, 1,2,4-triazole, tetrazole, Δ⁴-1,2-diazolin-3-one, piperidine, tetrahydro-1,4-oxazine, tetrahydro-1,4-thiazine, hexahydro-1,3-diazine, hexahydro-1,4-diazine, 1-methylhexahydro-1,4-diazine, hexahydro-1,3,5-triazine, hexahydro-1,3-diazin-4-one, 4-methylhexahydro-1,4-diazin-3-one, 1H-azepine, hexahydroazepine, octahydroazocine, 1H-benzo[b]pyrrole, 2,3-dihydrobenzo[b]pyrrole, 9H-dibenzopyrrole, benzo[d]-1,2-diazole, benzo[d]-1,3-diazole and benzo[d]-1,2,3-triazole.

Particular preference is given to pyrrolidine, piperidine, tetrahydro-1,4-oxazine, tetrahydro-1,4-thiazine, tetrahydro-1,4-diazine and 1-methyltetrahydro-1,4-diazine, especially tetrahydro-1,4-oxazine.

Examples of heterocyclic compounds (B) are 1-(triethoxysilylmethyl)aziridine, 1-(triethoxysilylmethyl)azetidine, 1-(triethoxysilylmethyl)pyrrole, 1-(triethoxysilylme-thyl)pyrrolidine, 3-(triethoxysilylmethyl)-1,3-oxazolidine, 3-(triethoxysilylmethyl)-1,3-thiazolidine, 1-(triethoxysilylme-thyl)-1H-1,2-diazole, 1-(triethoxysilylmethyl)-Δ²-1,2-diazoline, 1-(triethoxysilylmethyl)-Δ⁴-1,2-diazoline, 1-(tri-ethoxysilylmethyl)-1,3-diazole, 1-(triethoxysilylmethyl)-Δ²-1,3-diazoline, 1-(triethoxysilylmethyl)-Δ⁴-1,3-diazoline, 1-(triethoxysilylmethyl)-1,3-diazolidine, 1,3-bis(triethoxysilyl-methyl)-1,3-diazolidine, 1-(triethoxysilylmethyl)-1H-1,2,3-triazole, 2-(triethoxysilylmethyl)-2H-1,2,3-triazole, 1-(tri-ethoxysilylmethyl)-1H-1,2,4-triazole, 4-(triethoxysilylmethyl)-4H-1,2,4-triazole, 1-(triethoxysilylmethyl)-1H-tetrazole, 2-(triethoxysilylmethyl)-2H-tetrazole, 1-(triethoxysilylmethyl)-Δ⁴-1,2-diazolin-3-one, 1-(triethoxysilylmethyl)piperidine, 4-(triethoxysilylmethyl)tetrahydro-1,4-oxazine, 4-(1-(triethoxy-silyl)ethyl)tetrahydro-1,4-oxazine, 4-(2-(triethoxysilyl)prop-2-yl)tetrahydro-1,4-oxazine, 4-(1-phenyl-1-(triethoxysilyl)-ethyl)tetrahydro-1,4-oxazine, 4-(triethoxysilylmethyl)-tetrahydro-1,4-thiazine, 1-(triethoxysilylmethyl)hexahydro-1,3-diazine, 1-(triethoxysilylmethyl)hexahydro-1,4-diazine, 1-methyl-4-(triethoxysilylmethyl)hexahydro-1,4-diazine, 1,4-bis(triethoxysilylmethyl)hexahydro-1,4-diazine, 1,4-bis(1-(triethoxysilyl)ethyl)hexahydro-1,4-diazine, 1-(triethoxysilyl-methyl)hexahydro-1,3,5-triazine, 1,3-bis(triethoxysilylmethyl)-hexahydro-1,3,5-triazine, 1,3,5-tris(triethoxysilylmethyl)-hexahydro-1,3,5-triazine, 1-(triethoxysilylmethyl)hexahydro-1,3-diazin-4-one, 1-(triethoxysilylmethyl)-4-methylhexahydro-1,4-diazin-3-one, 1-(triethoxysilylmethyl)-1H-azepine, 1-(tri-ethoxysilylmethyl)hexahydroazepine, 1-(triethoxysilylmethyl)-octahydroazocine, 1-(triethoxysilylmethyl)benzo[b]pyrrole, 1-(triethoxysilylmethyl)-2,3-dihydrobenzo[b]pyrrole, 9-(trieth-oxysilylmethyl)dibenzopyrrole, 1-(triethoxysilylmethyl)-benzo[d]-1,2-diazole, 1-(triethoxysilylmethyl)benzo[d]-1,3-diazole and 1-(triethoxysilylmethyl)benzo[d]-1,2,3-triazole.

Further examples are all the abovementioned compounds in which the triethoxysilyl radical has been replaced by a trimethoxysilyl radical, diethoxymethylsilyl radical or dimethoxymethylsilyl radical.

The heterocyclic compounds (B) used in accordance with the invention are standard commercial compounds or are preparable by standard chemical methods.

The compositions of the invention contain component (B) in amounts of preferably 0.1 to 30 parts by weight, more preferably 0.5 to 20 parts by weight, especially 1 to 10 parts by weight, based in each case on 100 parts by weight of component (A).

The organosilicon compounds (A) used in accordance with the invention may be any organosilicon compounds having at least two OH groups that have also been used to date in compositions crosslinkable by condensation reaction.

The organosilicon compounds (A) used in accordance with the invention are preferably those containing units of the formula

R³_{b}(OH)_{c}SiO_{(4-b-c)/2} (II)
where
R³ may be the same or different and denotes optionally substituted hydrocarbyl radicals that may be interrupted by oxygen atoms,
b is 0, 1, 2 or 3, preferably 2, and
c is 0, 1, 2 or 3, preferably 0 or 1,
with the proviso that the sum of b+c≤3 and at least two condensable OH radicals are present per molecule.

Radical R³ is preferably monovalent hydrocarbyl radicals which have 1 to 18 carbon atoms and are optionally substituted by halogen atoms, amino groups, ether groups, ester groups, epoxy groups, mercapto groups, cyano groups or (poly)glycol radicals, where the latter are formed from oxyethylene and/or oxypropylene units, more preferably alkyl radicals having 1 to 12 carbon atoms, especially the methyl radical.

Examples of radical R³ are the examples given for radical R.

More preferably, organosilicon compounds (A) used in accordance with the invention are essentially linear, OH-terminated organopolysiloxanes, especially α, ω-dihydroxydialkylpoly-siloxanes.

Examples of organosilicon compounds (A) are (HO)Me₂SiO[SiMe₂O]_{30_2000}SiMe₂(OH) with Me=methyl radical.

The organosilicon compounds (A) used in accordance with the invention have a viscosity of preferably 103 to 10⁶ mPas, more preferably of 10⁴ to 350 000 mPas, in each case at 25° C.

The organosilicon compounds (A) are commercial products or can be prepared by standard methods in silicon chemistry.

Examples of radicals R⁴ are independently the examples given above for radical R.

Radical R⁴ is preferably alkyl radicals having 1 to 4 carbon atoms, more preferably the methyl radical or the ethyl radical.

The compounds (C) used in accordance with the invention contain units of the formulae (III), (IV), and (V) in total amounts of preferably at least 70 mol %, more preferably at least 85 mol %, especially at least 90 mol %.

The compounds (C) used in accordance with the invention contain at least 10 mol % of units of the formula (V), preferably 10 to 50 mol % and more preferably 12 to 30 mol %.

The compounds (C) used in accordance with the invention preferably contain 15 to 60 mol % of units of the formula (III).

The compounds (C) used in accordance with the invention preferably contain 20 to 60 mol % of units of the formula (IV).

The compounds (C) used in accordance with the invention preferably contain 10 to 50 mol % of units of the formula (V), 15 to 60 mol % of units of the formula (III) and 20 to 60 mol % of units of the formula (IV).

The compounds (C) used in accordance with the invention, apart from the units of the formulae (III), (IV) and (V), may also contain units of the formula (VI), which is not preferred.

If the compounds (C) used in accordance with the invention contain units of the formula (VI), there are preferably less than 2 mol % of units.

Preferably, the compounds (C) used in accordance with the invention consist of units of the formulae (III), (IV) and (V) and optionally (VI).

Although not expressed by the formulae (III) to (VI), the compounds (C) used in accordance with the invention, as a result of the preparation, may contain up to 1% by weight of residual Si—OH as an impurity.

Examples of siloxanes (C) used in accordance with the invention are
(Si(OEt)₂O_{2/2})_{0.42} (Si(OEt)O_{3/2})_{0.19}(Si(OEt)₃O_{1/2})_{0.39} with Mw=1000 g/mol, Mn=800 g/mol and Mw/Mn=1.2 and
(Si(OEt)₂O_{2/2})_{0.47}(Si(OEt)O_{3/2})_{0.35} (Si(OEt)₃O_{1/2})_{0.16} (SiO_{4/2})_{0.02} with Mw=1400 g/mol, Mn=900 g/mol and Mw/Mn=1.6.

The siloxanes (C) have a weight average Mw of preferably 500 to 10 000 g/mol, more preferably of 500 to 8000 g/mol.

The siloxanes (C) have a number average Mn of preferably 200 to 5000 g/mol, more preferably of 200 to 3000 g/mol.

The siloxanes (C) have polydispersities Mw/Mn of preferably 1 to 5, more preferably of 1 to 4.

In the present invention, weight averages Mw and number averages Mn, rounded to whole hundreds in accordance with DIN 1333:1992-02 Part 4, are determined by gel permeation chromatography (GPC or size exclusion chromatography (SEC)) in accordance with DIN 55672-1 with a polystyrene standard and refractive index detector (RI detector). Unless indicated otherwise, THF is used as eluent for phenyl-containing components and toluene as eluent for non-phenyl-containing components, and the analyses are conducted at a column temperature of 45° C. The polydispersity is the quotient Mw/Mn.

Organosiloxanes (C) are preferably liquid at 25° C. and 1000 hPa.

The siloxanes (C) used in accordance with the invention are commercially available, for example under the WACKER® TES 40 name from Wacker Chemie AG, Munich, Germany, or can be prepared by standard methods in silicon chemistry. For example, the compounds (C) used in accordance with the invention can be prepared by hydrolysis and subsequent condensation of tetraalkoxysilanes.

The compositions of the invention contain component (C) in amounts of preferably 1 to 20 parts by weight, more preferably 4 to 10 parts by weight, based in each case on 100 parts by weight of component (A).

In addition to components (A), (B) and (C), the compositions of the invention may then contain all the substances that have also been used to date in compositions crosslinkable by condensation reaction, for example catalysts (D), compound (E) containing basic nitrogen, fillers (F), adhesion promoters (G), plasticizers (H), further crosslinkers (J), additives (K) and solvents (L), where components (J), (E) and (G) are different than components (B) and (C), and component (L) is different than plasticizers (H).

Examples of catalysts (D) are the titanium compounds already known, such as tetraisopropoxytitanate, zirconium compounds and hafnium compounds, and metal carboxylates, such as zinc (2-ethylhexoate), and octylphosphonic acid or derivatives thereof.

Any catalysts (D) used are preferably alkoxides of metals of the fourth transition group of the Periodic Table of the Elements, carboxylates of metals of the twelfth transition group of the Periodic Table of the Elements, and phosphonic esters, more preferably alkoxides of titanium, carboxylates of zinc and derivatives of octylphosphonic acid, especially tetrabutyl titanate, zinc ethylhexanoate or octylphosphonic esters.

If the compositions of the invention contain catalyst (D) the amounts are preferably 0.0001 to 2 parts by weight, more preferably 0.001 to 1 parts by weight, based in each case on 100 parts by weight of the composition of the invention. The compositions of the invention preferably contain catalyst (D).

The compositions of the invention contain organotin compounds preferably in amounts of not more than 0.01 parts by weight, more preferably of not more than 0.001 parts by weight, based in each case on 100 parts by weight of the composition of the invention, where the compositions of the invention are especially free of organotin compounds.

Any compounds (E) containing basic nitrogen that are used in accordance with the invention are preferably those selected from the group consisting of compounds of the formula

NR⁶₃ (IX)
where R⁶ may be the same or different and is a hydrogen atom or hydrocarbyl radicals optionally substituted by hydroxy groups, halogen atoms, amino groups, ether groups, ester groups, epoxy groups, mercapto groups, cyano groups or polyglycol residues, where the latter are formed from oxyethylene and/or oxypropylene units,
with the proviso that, in formula (IX), not more than two R⁶ have the meaning of a hydrogen atom, where, if two or more R⁶ are present, these may also be joined to one another to form cyclic structures,
and organosilicon compounds having at least one organic radical containing basic nitrogen that are different than component (B), composed of units of the formula

R⁷ₖY₁Si(OR⁸)ₘO_{(4-k-1-m)/2} (X),
in which
R⁷ may be the same or different and is a monovalent, SiC-bonded organic radical which is free of basic nitrogen,
R³ may be the same or different and has a definition given for radical R²,
Y may be the same or different and is a monovalent, SiC-bonded organic radical containing basic nitrogen,
k is 0, 1, 2, or 3,
1 is 0, 1, 2, 3 or 4 and
m is 0, 1, 2 or 3,
with the proviso that the sum of k+l+m is not more than 4 and at least one radical Y is present per molecule.

Examples of R⁶ and R⁷ radicals are in each case independently the examples of optionally substituted hydrocarbyl radicals that are given for R.

The optionally substituted hydrocarbyl radicals R⁶ are preferably those having 1 to 18 carbon atoms.

Radical R⁷ is preferably hydrocarbyl radicals having 1 to 18 carbon atoms, particular preference being given to methyl, ethyl and n-propyl radicals, especially the methyl radical.

Examples of radical R⁸ are the examples given for radical R².

Radical R³ is preferably the methyl and ethyl radical.

Examples of radicals Y are radicals of the formulae H₂NCH₂—, H₂N(CH₂)₂—, H₂N(CH₂)₃—, H₂N(CH₂)₂NH(CH₂)₂—, H₂N(CH₂)₂NH(CH₂)₃—, H₂N(CH₂)₂NH(CH₂)₂NH(CH₂)₃—, H₃CNH(CH₂)₃—, C₂H₅NH(CH₂)₃—, H₃CNH(CH₂)₂—, C₂H₅NH(CH₂)₂—, H₂N(CH₂)₄—, H₂N(CH₂)₅—, H(NHCH₂CH₂)₃—, C₄H₉NH(CH₂)₂NH(CH₂)₂—, cyclo-C₆H₁₁NH(CH₂)₃—, cyclo-C₆H₁₁NH(CH₂)₂—, (CH₃)₂N(CH₂)₃—, (CH₃)₂N(CH₂)₂—, (C₂H₅)₂N(CH₂)₃— and (C₂H₅)₂N(CH₂)₂—.

Preferably, Y is H₂N(CH₂)₃—, H₂N(CH₂)₂NH(CH₂)₃—, H₃CNH(CH₂)₃—, C₂H₅NH(CH₂)₃— and cyclo-C₆H₁₁NH(CH₂)₃— radical, particular preference being given to H₂N(CH₂)₂NH(CH₂)₃- and cyclo-C₆H₁₁NH(CH₂)₃— radical.

If the organosilicon compounds composed of units of the formula (X) are silanes, k is preferably 0, 1 or 2, more preferably 0 or 1, 1 is preferably 1 or 2, more preferably 1, and m is preferably 1, 2 or 3, more preferably 2 or 3, with the proviso that the sum of k+l+m=4.

Examples of the silanes of the formula (X) that are optionally used in accordance with the invention are H₂N(CH₂)₃—Si(OCH₃)₃, H₂N(CH₂)₃—Si(OC₂H₅)₃, H₂N(CH₂)₃—Si(OCH₃)₂CH₃, H₂N(CH₂)₃—Si(OC₂H₅)₂CH₃, H₂N(CH₂)₂NH(CH₂)₃—Si(OCH₃), H₂N(CH₂)₂NH(CH₂)₃—Si(OC₂H₅)₃, H₂N(CH₂)₂NH(CH₂)₃—Si(OCH₃)₂CH₃, H₂N(CH₂)₂NH(CH₂)₃—Si(OC₂H₅)₂CH₃, H₂N(CH₂)₂NH(CH₂)₂NH(CH₂)₃—Si(OC₂H₅)₃, cyclo-C₆H₁₁NH(CH₂)₃—Si(OCH₃)₃, cyclo-C₆H₁₁NH(CH₂)₃—Si(OC₂H₅)₃, cyclo-C₆H₁₁NH(CH₂)₃—Si(OCH₃)₂CH₃, cyclo-C₆H₁₁NH(CH₂)₃—Si(OC₂H)₂CH₃,
HN((CH₂)₃—Si(OCH₃)₃)₂ and HN((CH₂)₃—Si(OC₂H) 3)₂ and partial hydrolyzates thereof, preference being given to
H₂N(CH₂)₂NH(CH₂)₃—Si(OCH₃)₃,
H₂N(CH₂)₂NH(CH₂)₃-Si(OC₂H₅)₃, H₂N(CH₂)₂NH(CH₂)₃-Si(OCH₃)₂CH₃,
H₂N(CH₂)₂NH(CH₂)₃—Si(OC₂H)₂CH₃, cyclo-C₆H₁₁NH(CH₂)₃—Si(OC₂H₅)₃, cyclo-C₆H₁₁NH(CH₂)₃—Si(OCH₃)₂CH₃ and cyclo-C₆H₁₁NH(CH₂)₃—Si(OC₂H₅)₂CH₃, and particular preference to
H₂N(CH₂)₂NH(CH₂)₃—Si(OC₂H₅)₃, H₂N(CH₂)₂NH(CH₂)₃—Si(OC₂H₅)₂CH₃, cyclo-C₆H₁₁NH(CH₂)₃—Si(OC₂H₅)₃ and cyclo-C₆H₁₁NH(CH₂)₃—Si(OC₂H)₂CH₃ and the partial hydrolyzates of each.

If the organosilicon compound composed of units of the formula (X) is an organopolysiloxane, the average value of k is preferably between 0.5 and 2.5, more preferably between 1.4 and 2.0, the average value of 1 is preferably between 0.01 and 1.0, more preferably between 0.01 and 0.6, and the average value of m is preferably between 0 and 2.0, more preferably between 0 and 0.2, with the proviso that the sum of k, 1 and m is not more than 3.

The organopolysiloxanes composed of units of the formula (X) that are usable in accordance with the invention have a viscosity at 25° C. of preferably 5 to 10⁵ mPas, more preferably of 10 to 10⁴ mPas.

Examples of the organopolysiloxanes composed of units of the formula (X) that are usable in accordance with the invention are
H₂N(CH₂)₃—Si(OCH₃)₂—O—Si(CH₃) (OCH₃)₂,
H₂N(CH₂)₃—Si(OC₂H₅)₂—O—Si(CH₃) (OCH₃)₂,
H₂N(CH₂)₃—Si(OC₂H₅)₂—O—Si(CH₃) (OC₂H₅)₂,
H₂N(CH₂)₃—Si(OCH₃) (CH₃)—O—Si(CH₃) (OCH₃)₂,
H₂N(CH₂)₃—Si(OCH₃) (CH₃)—O—Si(OCH₃)₃,
H₂N(CH₂)₃—Si(OC₂H₅) (CH₃)—O—Si(OCH₃)₃,
H₂N(CH₂)₂NH(CH₂)₃—Si(OCH₃)₂—O—Si(CH₃) (OCH₃)₂,
H₂N(CH₂)₂NH(CH₂)₃—Si(OC₂H₅)₂—O—Si(CH₃) (OCH₃)₂,
H₂N(CH₂)₂NH(CH₂)₃—Si(OC₂H₅)₂—O—Si(CH₃) (OC₂H₅)₂,
H₂N(CH₂)₂NH(CH₂)₃—Si(OCH₃) (CH₃)—O—Si(CH₃) (OCH₃)₂,
H₂N(CH₂)₂NH(CH₂)₃—Si(OCH₃) (CH₃)—O—Si(OCH₃)₃,
H₂N(CH₂)₂NH(CH₂)₃—Si(OC₂H₅) (CH₃)—O—Si(OCH₃)₃,
cyclo-C₆H₁₁NH(CH₂)₃—Si(OCH₃)₂—O—Si(CH₃) (OCH₃)₂,
cyclo-C₆H₁₁NH(CH₂)₃—Si(OC₂H₅)₂—O—Si(CH₃) (OCH₃)₂,
cyclo-C₆H₁₁NH(CH₂)₃—Si(OC₂H₅)₂—O—Si(CH₃) (OC₂H₅)₂,
cyclo-C₆H₁₁NH(CH₂)₃—Si(OCH₃) (CH₃)—O—Si(CH₃) (OCH₃)₂,
cyclo-C₆H₁₁NH(CH₂)₃—Si(OCH₃) (CH₃)—O—Si(OCH₃)₃ and
cyclo-C₆H₁₁NH(CH₂)₃—Si(OC₂H₅) (CH₃)—O—Si(OCH₃)₃,
H₂N(CH₂)₃—Si(OCH₃)₂—O—Si(CH₃)₂)₁₋₁₀₀—O—Si(OCH₃)₂—(CH₂)₃NH₂,
H₂N(CH₂)₂NH(CH₂)₃—Si(OCH₃)₂—(O—Si(CH₃)₂)₁₋₁₀₀—O—Si(OCH₃)₂—(CH₂)₃
NH(CH₂)₂NH₂ and cyclo-C₆H₁₁NH(CH₂)₃—Si(OCH₃)₂— (O—Si(CH₃)₂)₁₋₁₀₀—O—Si(OCH₃)₂—(CH₂)₃NH cyclo-C₆H₁₁ and partial hydrolyzates thereof, particular preference being given to a partial hydrolyzate of H₂N(CH₂)₃—Si(OC₂H₅)₂—O—Si(CH₃) (OC₂H₅)₂.

Organosilicon compounds composed of units of the formula (X) are commercial products or can be prepared by standard methods in silicon chemistry.

Examples of amines of the formula (IX) are cyclohexylamine, triethylamine, trioctylamine, butylamine, dodecylamine, diethyl-n-propylamine, cyclohexylmethylamine, 2-aminoethanol, 2-amino-n-propanol, 2-amino-2-methyl-1-propanol, 2-dimethylamino-2-methyl-1-propanol, N,N-diethylethanolamine, ethylenediamine, cocoamine, cocomethylamine, N,N-dimethylethanolamine and aniline.

If component (E) is used, it preferably comprises organosilicon compounds composed of units of the formula (X).

If the compositions of the invention contain component (E), the amounts are preferably 0.001 to 10 parts by weight, more preferably 0.01 to 1 parts by weight, based in each case on 100 parts by weight of the composition of the invention. The compositions of the invention preferably contain component (E).

Any organosilicon compounds (E) used in accordance with the invention may also assume the function of a curing catalyst or cocatalyst in the compositions of the invention.

In addition, any organosilicon compounds (E) used in accordance with the invention may act as adhesion promoters and/or as water scavengers. Examples of fillers (F) are nonreinforcing fillers, i.e. fillers having a BET surface area of up to 50 m²/g, such as quartz, diatomaceous earth, calcium silicate, zirconium silicate, zeolites, metal oxide powders, such as aluminum oxides, titanium oxides, iron oxides or zinc oxides or mixed oxides thereof, barium sulfate, calcium carbonate, gypsum, silicon nitride, silicon carbide, boron nitride, glass powders and polymer powders, such as polyacrylonitrile powder; reinforcing fillers, i.e. fillers having a BET surface area of more than 50 m²/g, such as fumed silica, precipitated silica, precipitated calcium carbonate, carbon black, such as furnace black and acetylene black, and mixed silicon-aluminum oxides of high BET surface area; fibrous fillers, such as asbestos, and polymer fibers. The fillers mentioned may have been hydrophobized, for example by treatment with organosilanes or -siloxanes or by etherification of hydroxyl groups to alkoxy groups. If fillers (F) are used, they are preferably hydrophilic fumed silica, precipitated calcium carbonate and ground marble.

If the compositions of the invention contain component (F), the amounts are preferably 1 to 80 parts by weight, more preferably 5 to 65 parts by weight, based in each case on 100 parts by weight of composition of the invention. The compositions of the invention preferably contain component (F).

Any adhesion promoter (G) used in the compositions of the invention may be silanes and organopolysiloxanes having functional groups, for example those having glycidoxypropyl, ureidopropyl or methacryloyloxypropyl radicals. Examples of adhesion promoters (G) are epoxysilanes, such as glycidoxypropyltrimethoxysilanes, glycidoxypropylmethyldimeth-oxysilane, glycidoxypropyltriethoxysilane or glycidoxypropyl-methyldiethoxysilane, tris[3-(trimethoxysilyl)propyl]isocyanurate, 2-(3-triethoxysilylpropyl)maleic anhydride, N-(3-trimethoxysilylpropyl)urea, N-(3-triethoxysilylpropyl)urea, N-(trimethoxysilylmethyl)urea, N-(methyldimethoxysily-lmethyl)urea, N-(3-triethoxysilylmethyl)urea, N-(3-methyldiethoxysilylmethyl)urea, O-methylcarbamatome-thylmethyldimethoxysilane, O-methylcarbamatomethyltrimethoxy-silane, O-ethylcarbamatomethyl-methyldiethoxysilane, O-ethyl-carbamatomethyltriethoxysilane, 3-methacryloyloxypropyltrimeth-oxysilane, methacryloyloxymethyl-trimethoxysilane, methacryloyloxymethylmethyldimethoxysilane, methacryloyloxymethyltriethoxysilane, methacryloyloxymethyl-methyldiethoxysilane, 3-acryloyloxypropyltrimethoxysilane, acryloyloxymethyltrimethoxysilane, acryloyloxymethylmethyl-dimethoxysilane, acryloyloxymethyltriethoxysilane and acryloyl-oxymethylmethyldiethoxysilane and partial condensates thereof.

If the compositions of the invention contain component (G), the amounts are preferably 0.01 to 10 parts by weight, more preferably 0.1 to 2.5 parts by weight, based in each case on 100 parts by weight of the composition of the invention. The compositions of the invention, except when calcium carbonates are used as filler, preferably do not contain any component (G). If the compositions of the invention contain calcium carbonate as filler (F), the use of component (G) is preferred.

Examples of plasticizers (H) are room-temperature-liquid dimethylpolysiloxanes having end blocking by trimethylsiloxy groups, especially having viscosities at 25° C. in the range between 5 and 10 000 mPas, and high-boiling hydrocarbons, for example paraffin oils or mineral oils consisting of naphthenic and paraffinic units.

If the compositions of the invention contain component (H), the amounts are preferably 1 to 50 parts by weight, more preferably 10 to 35 parts by weight, based in each case on 100 parts by weight of the composition of the invention. The compositions of the invention preferably contain component (H).

Any further crosslinkers (J) used in the compositions of the invention may be any crosslinkers known to date that have at least three condensable radicals, for example silanes having at least three organyloxy groups that are different than component (B).

Any further crosslinkers (J) used in the compositions of the invention are preferably silane crosslinkers, such as methyltrimethoxysilane, methyltriethoxysilane, vinyltrimethoxysilane, vinyltriethoxysilane, phenyltrimethoxysilane, phenyltriethoxysilane, 1,2-bis(trimeth-oxysilyl)ethane or 1,2-bis(triethoxysilyl)ethane and partial hydrolyzates thereof.

Further crosslinkers (J) used are more preferably partial hydrolyzates of alkyltrialkoxysilanes, very particular preference being given to partial hydrolyzates of methyltrimethoxysilane.

Any further crosslinkers (J) used in the compositions of the invention are commercial products or can be prepared by methods known in silicon chemistry. Partial hydrolyzates of methyltrimethoxysilane are commercially available, for example, from Wacker Chemie AG, Munich, Germany, under the TRASIL brand name.

If the compositions of the invention contain further crosslinkers (J), the amounts are preferably 0.1 to 10 parts by weight, more preferably 0.2 to 5 parts by weight, even more preferably 0.5 to 3 parts by weight, based in each case on 100 parts by weight of the composition of the invention. The compositions of the invention preferably contain crosslinkers (J).

Examples of additives (K) are pigments, dyes, odorants, oxidation inhibitors, agents for influencing electrical properties, such as conductive carbon black, flame retardants, light stabilizers and skin time extenders, such as silanes having an SiC-bonded mercaptoalkyl radical, cell generators, e.g. azodicarbonamide, heat stabilizers and thixotropic agents, for example polyethers, biocides such as fungicides, bactericides, acaricides and modulus regulators such as polydimethylsiloxanes having just one OH end group, and storage stability improvers, such as alkylphosphonic acids.

If the compositions of the invention contain component (K), the amounts are preferably 0.0001 to 10 parts by weight, more preferably 0.001 to 10 parts by weight, based in each case on 100 parts by weight of the composition of the invention. The compositions of the invention preferably contain component (K).

Examples of solvents (L) are toluene, xylene, ethanol and methanol. These may, for example as a result of production, be present as impurities in one or more of constituents (A) to (K), or may be added deliberately, for instance when component (C) is to be used as solvent mixture.

If the compositions of the invention contain solvents (L), the amounts are preferably 0.01 to 2 parts by weight, more preferably 0.1 to 1 parts by weight, based in each case on 100 parts by weight of the composition of the invention. The compositions of the invention preferably do not contain any solvents (L). The compositions of the invention are preferably those producible using
(A) organosilicon compounds containing units of the formula (II),
(B) compounds of the formula (I),
(C) compounds containing units of the formulae (III), (IV) and
(V) in total amounts of at least 80 mol %, with the proviso that they include at least 10 mol % of units of the formula (V),
optionally (D) catalysts,
optionally (E) compounds containing basic nitrogen,
optionally (F) fillers,
optionally (G) adhesion promoters,
optionally (H) plasticizers,
optionally (J) further crosslinkers,
optionally (K) additives and
optionally (L) solvents.

In addition, the compositions of the invention are preferably those producible using
(A) essentially linear, OH-terminated organopolysiloxanes,
(B) compounds of the formula (I), where the heterocycles on which the radicals A are based are pyrrolidine, piperidine, tetrahydro-1,4-oxazine, tetrahydro-1,4-thiazine, tetrahydro-1,4-diazin and 1-methyltetrahydro-1,4-diazine, especially tetrahydro-1,4-oxazine,
(C) compounds containing units of the formulae (III), (IV) and
(V) in total amounts of at least 90 mol %, with the proviso that they include 12 to 30 mol % of units of the formula (V), optionally (D) catalysts,
(E) compounds containing basic nitrogen,
optionally (F) fillers,
optionally (G) adhesion promoters,
optionally (H) plasticizers,
optionally (J) further crosslinkers,
optionally (K) additives and
optionally (L) solvents.

More preferably, the compositions of the invention are produced using no constituents beyond components (A) to (L).

The individual constituents of the compositions of the invention may each be one kind of such constituent, or else a mixture of at least two different kinds of such constituents.

For preparation of the compositions of the invention, all constituents may be mixed with one another in any sequence.

This mixing can be effected at room temperature and the pressure of the surrounding atmosphere, i.e. about 900 to 1100 hPa, or under a reduced pressure of about 20 hPa to 800 hPa. However, if desired, this mixing may alternatively be effected at higher temperatures, for example at temperatures in the range from 35 to 135° C. Heating or cooling is possible if desired.

The present invention further provides a process for producing the composition of the invention by mixing the individual components in any sequence.

The inventive mixing of the individual components preferably takes place with very substantial exclusion of water from the surrounding atmosphere, which can be achieved, for example, by blanketing with dry air.

Component (C) used in accordance with the invention can be mixed in at any time, for example before the addition of compound (B) to organosilicon compound (A), before or after the addition of the fillers (F) or as the last component, in each case also before or after degassing. It is preferably added before the fillers (F).

The sequence in which polymer, crosslinker and plasticizer are mixed is immaterial. For reasons of convenient processing, an initial charge is preferably first formed by polymer (A) and optionally plasticizer (H), and then component (B) and optionally crosslinker (J) are added, after which component (C) is preferably added.

If fillers (F) are added, preference is given to mixing component (A), component (B), component (C), optionally component (J) and optionally component (E) intimately with one another before filler (F), preferably hydrophilic silica, is added.

Preferably, if component (E) is used, the ratio of (E) to (F) is chosen such that, for every square meter of BET surface area of the filler (F), at least 0.2 μmol of compounds (E) containing basic nitrogen is used.

If fillers (F) and plasticizers (H) are added, the mixture of polymer (A), plasticizer (H), component (C) and component (B) and optionally crosslinker (J) is mixed intimately by stirring.

If hydrophilic fumed silica is added as fillers (F), preference is given to intimately mixing component (A), plasticizer (H), component (C), component (B) and optionally components (J) prior to the addition of filler (F) until at least 90% of the OH groups of the organosilicon compound (A) have reacted with constituents (B) and (J), with the addition of component (E) at any time prior to the addition of the fumed silica. The ratio of (E) to (F) is preferably chosen such that 0.2 μmol of compounds (E) containing basic nitrogen is used per square meter of BET surface area of the filler.

In addition, the point at which catalyst (D) is added is generally immaterial. However, it is sensible only to add the catalyst at the end since the mixture is then activated. The person skilled in the art will generally wish to avoid excessively long mixing of already very reactive sealing compounds, since complete exclusion of moisture in the producing of the mixture is difficult or at least uneconomic. Sometimes it is even necessary for the catalyst not to come into contact with a polymer-crosslinker mixture that still contains relatively large amounts of unconverted OH groups since premature crosslinking of the mixture can then sometimes take place. For that reason too, the person skilled in the art will avoid adding the catalyst too early. By way of exception, the person skilled in the art will add the crosslinking catalyst at the start of mixture production only when it is simultaneously the catalyst for the reaction of the OH polymers with the crosslinker.

The mixing of the constituents can be interrupted for any amount of time at any point. In particular, preference is given to an interruption of at least about 1 minute after the organosilicon compound (A) has been mixed with compound (B) and any component (E)/any crosslinker (J), preferably with addition of component (C) only after the interruption.

After all the desired constituents have been mixed, the mixture is preferably degassed and introduced into moisture-tight containers.

The inventive production of the crosslinkable compositions of the invention can be conducted either batchwise or continuously.

In the continuous procedure, preference is given to first mixing organosilicon compound (A) with compound (B) and any plasticizers (H) in a continuous manner, preferably with a dynamic mixer, where the reaction time of organosilicon compound (A) with compounds (B) is 1 to 60 minutes, before any further mixture constituents are mixed in. For example, the reaction times can be adjusted by means of controlled design of conduit lengths and conduit cross section in the continuous system. The reaction time in the continuous process of the invention is preferably such that at least 90% of the OH groups of the organosilicon compound (A) have reacted with compounds (B). Subsequently, it is possible to use a static mixer, for example, to continuously mix in the organosilicon compound (C) of the invention and any crosslinker (J), compound (E) containing basic nitrogen, adhesion promoter (G) and plasticizer (H).

If desired, this is followed, preferably without intermediate storage, by the continuous mixing-in of fillers (F), such as finely divided silica, for which it is possible to use, for example, mixers with a rotor/stator system.

Prior to the possible addition of the catalyst (D) and of additives (K), the composition of the invention may be continuously degassed, for example with the aid of a twin-screw extruder.

The compositions of the invention are preferably one-component compositions that are storable with exclusion of water and cure on ingress of water, which are generally referred to in the specialist field as RTV-1 compositions.

The customary water content of air is sufficient for the crosslinking of the compositions of the invention. The compositions of the invention are preferably crosslinked at room temperature. This can, if desired, also be conducted at higher or lower temperatures than room temperature, for example at −5° to 15° C. or at 30° to 50° C. and/or by means of water concentrations that exceed the normal water content of air.

The crosslinking is preferably conducted at a pressure of 100 to 1100 hPa, especially at the pressure of the surrounding atmosphere.

The present invention further provides shaped articles produced by crosslinking the compositions of the invention.

The compositions of the invention may be used for all end uses for which it is possible to use compositions that are storable with exclusion of water and crosslink on ingress of water at room temperature to give elastomers.

The compositions of the invention are thus of excellent suitability, for example, as sealing compounds for joins, including vertical joins, and similar cavities, for example of clear width 10 to 40 mm, for example in buildings, land vehicles, watercraft and aircraft, or as adhesives or putties, for example in window construction or in the production of aquariums or glass cabinets, and also, for example, for production of protective coatings, including those for surfaces that are exposed to the constant action of freshwater or seawater, or nonslip coatings, or of elastomeric shaped articles and for the insulation of electrical or electronic devices.

The compositions of the invention have the advantage that they are easy to produce and have high storage stability over a long period of time.

The compositions of the invention have the advantage that they form only small proportions, if any, of cleavage products of toxicological concern.

The compositions of the invention have the advantage that only small proportions, if any, of catalysts of toxicological concern are present.

The compositions of the invention have the advantage of having high resistance to deformation when worked.

The compositions of the invention have the advantage that, when aqueous smoothing agents are used, no readily visible spots are formed on the surface of the sealant.

In addition, the compositions of the invention have the advantage that it is possible to adjust skin time within wide limits.

In addition, the compositions of the invention have the advantage that they can be produced entirely continuously.

In addition, the compositions of the invention have the advantage that variation of the type and proportion of compound (C) allows controlled adjustment of the modulus of the cured compositions within an extremely wide scope. At the same time, the rheological properties of the uncured compositions remain virtually unchanged, which is generally desirable.

In the examples described hereinafter, all viscosity figures relate to a temperature of 25° C. Unless stated otherwise, the examples that follow are conducted at a pressure of the surrounding atmosphere, i.e. roughly at 1000 hPa, and at room temperature, i.e. at about 23° C., or at a temperature established on combination of the reactands at room temperature without additional heating or cooling, and at a relative humidity of about 50%. In addition, all parts and percentage figures, unless stated otherwise, are based on weight.

The abbreviations used in the examples have the following meaning:
Me: methyl radical
Et: ethyl radical

Hydrolyzate (S1): oligomeric tetraethoxysilane hydrolyzate consisting of 39 mol % of units of the formula Si(OEt)₃O_{1/2}, 42 mol % of units of the formula Si(OEt)₂O_{2/2} and 19 mol % of units of the formula (OEt)SiO₃/2.

Hydrolyzate (S2): oligomeric tetraethoxysilane hydrolyzate consisting of 16 mol % of units of the formula Si(OEt)₃O_{1/2}, 47 mol % of units of the formula Si(OEt)₂O_{2/2}, 35 mol % of units of the formula (OEt)SiO_{3/2}, and 2 mol % of units of the formula Si(OEt)_{4.}

Product (P): oligomeric silane hydrolyzate consisting of 16.0 mol % of units of the formula MeSi(OEt)₂O_{1/2}, 46.4 mol % of units of the formula MeSi(OEt)O_{2/2}, 36.5 mol % of units of the formula MeSiO_{3/2}, 0.2 mol % of units of the formula Me₂Si(OEt)O_{1/2} and 0.9 mol % of units of the formula Me₂SiO_{2/2}.

### Skin Time:

For the purposes of the present invention, the expression “skin time” defines the period of time before a thin elastic film forms on the surface of the composition that differs from the material beneath. If this surface is touched, for example, with the tip of a pencil, no material sticks thereto. A skin time of more than 30 minutes is a clear indication that the desirably rapid complete curing of the sealing compound is not achieved.

### Yield Point:

The measurement of the yield points was conducted with air-bearing rotary rheometers (MCR 301 rheometer from Anton Paar, Ostfildern-Scharnhausen, Germany). Before commencement of the measurement, the full cartridge was subjected to prior heat treatment at 25° C. in a climate-controlled cabinet for 3 hours. The measurement settings were as follows:
Temperature: 25° C.
Measuring element: PP25
Gap distance: 0.2 mm
Measurement mode: oscillation
Measurements: 5 per decade, every 10 sec
Shear stress: log 10 Pa-10000 Pa
Frequency: const. 1 Hz

The yield point corresponds to the interpolated shear stress in Pa at a loss factor of 1.

### Comparative Example 1 (V1)

An initial charge of 300 g of an α, ω-dihydroxypolydimethyl-siloxane having a viscosity of 80 000 mPa·s (commercially available under the “Polymer FD 80” name from Wacker Chemie AG, Munich, Germany), 130 g of an α, ω-bis(trimethylsiloxy)polydi-methylsiloxane having a viscosity of 1000 mPa·s (commercially available under the “Weichmacher 1000” name from Wacker Chemie AG, Munich, Germany), 9 g of 4-(triethoxysilylmethyl)-tetrahydro-1,4-oxazine, 5 g of product (P), 11 g of 3-aminopropyltriethoxysilane (commercially available under the GENIOSIL® GF 93 name from Wacker Chemie AG, Munich, Germany), 7 g of vinyltriethoxysilane (commercially available under the GENIOSIL® GF 56 name from Wacker Chemie AG, Munich, Germany) and 3.3 g of tetraethyl silicate (commercially available under the “Silikat TES 28” name from Wacker Chemie AG, Munich, Germany) was mixed in a planetary mixer for a period of 30 minutes. Subsequently, 45 g of a fumed silica having a specific BET surface area of 150 m²/g (commercially available under the HDK® V15 name from Wacker Chemie AG, Munich, Germany) was mixed in and fully homogenized at a pressure of 50 hPa.

The RTV1 composition thus obtained was dispensed into moisture-tight conventional polyurethane cartridges.

### Example 1

An initial charge of 300 g of an α, ω-dihydroxypolydimethyl-siloxane having a viscosity of 80 000 mPa·s (commercially available under the “Polymer FD 80” name from Wacker Chemie AG, Munich, Germany), 130 g of an α, ω-bis(trimethylsiloxy)polydi-methylsiloxane having a viscosity of 1000 mPa·s (commercially available under the “Weichmacher 1000” name from Wacker Chemie AG, Munich, Germany), 9 g of 4-(triethoxysilylmethyl)tetra-hydro-1,4-oxazine, 5 g of product (P), 11 g of 3-aminopropyltriethoxysilane (commercially available under the GENIOSIL® GF 93 name from Wacker Chemie AG, Munich, Germany), 7 g of vinyltriethoxysilane (commercially available under the GENIOSIL® GF 56 name from Wacker Chemie AG, Munich, Germany) and 3.3 g of the hydrolyzate (S1) was mixed in a planetary mixer for a period of 30 minutes. Subsequently, 45 g of a fumed silica having a specific BET surface area of 150 m²/g (commercially available under the HDK® name V15 from Wacker Chemie AG, Munich, Germany) was mixed in and fully homogenized at a pressure of 50 hPa.

The RTV1 composition thus obtained was dispensed into moisture-tight conventional polyurethane cartridges.

### Example 2

An initial charge of 300 g of an α, ω-dihydroxypolydimethyl-siloxane having a viscosity of 80 000 mPa·s (commercially available under the “Polymer FD 80” name from Wacker Chemie AG, Munich, Germany), 130 g of an α, ω-bis(trimethylsiloxy)polydi-methylsiloxane having a viscosity of 1000 mPa·s (commercially available under the “Weichmacher 1000” name from Wacker Chemie AG, Munich, Germany), 9 g of 4-(triethoxysilylmethyl)tetra-hydro-1,4-oxazine, 5 g of product (P), 11 g of 3-aminopropyltriethoxysilane (commercially available under the GENIOSIL® GF 93 name from Wacker Chemie AG, Munich, Germany), 7 g of vinyltriethoxysilane (commercially available under the GENIOSIL® GF 56 name from Wacker Chemie AG, Munich, Germany) and 3.3 g of the hydrolyzate (S1) was mixed in a planetary mixer for a period of 30 minutes. Subsequently, 45 g of a fumed silica having a specific BET surface area of 150 m²/g (commercially available under the HDK® V15 name from Wacker Chemie AG, Munich, Germany) was mixed in and fully homogenized at a pressure of 50 hPa. Lastly, 2.5 g of zinc(II) octoate was added and the mixture was homogenized once again at a pressure of about 50 hPa (absolute) for 5 min.

The RTV1 composition thus obtained was dispensed into moisture-tight conventional polyurethane cartridges.

### Example 3

An initial charge of 300 g of an α, ω-dihydroxypolydimethyl-siloxane having a viscosity of 80 000 mPa·s (commercially available under the “Polymer FD 80” name from Wacker Chemie AG, Munich, Germany), 130 g of an α, ω-bis(trimethylsiloxy)polydi-methylsiloxane having a viscosity of 1000 mPa·s (commercially available under the “Weichmacher 1000” name from Wacker Chemie AG, Munich, Germany), 9 g of 4-(triethoxysilylmethyl)tetra-hydro-1,4-oxazine, 5 g of product (P), 11 g of 3-aminopropyltriethoxysilane (commercially available under the GENIOSIL® GF 93 name from Wacker Chemie AG, Munich, Germany), 7 g of vinyltriethoxysilane (commercially available under the GENIOSIL® GF 56 name from Wacker Chemie AG, Munich, Germany) and 3.3 g of the hydrolyzate (S2) was mixed in a planetary mixer for a period of 30 minutes. Subsequently, 45 g of a fumed silica having a specific BET surface area of 150 m²/g (commercially available under the HDK® V15 name from Wacker Chemie AG, Munich, Germany) was mixed in and fully homogenized at a pressure of 50 hPa.

The RTV1 composition thus obtained was dispensed into moisture-tight conventional polyurethane cartridges.

### Example 4

An initial charge of 300 g of an α, ω-dihydroxypolydimethyl-siloxane having a viscosity of 80 000 mPa·s (commercially available under the “Polymer FD 80” name from Wacker Chemie AG, Munich, Germany), 130 g of an α, ω-bis(trimethylsiloxy)polydi-methylsiloxane having a viscosity of 1000 mPa·s (commercially available under the “Weichmacher 1000” name from Wacker Chemie AG, Munich, Germany), 9 g of 4-(triethoxysilylmethyl)tetra-hydro-1,4-oxazine, 5 g of product (P), 11 g of 3-aminopropyltriethoxysilane (commercially available under the GENIOSIL® GF 93 name from Wacker Chemie AG, Munich, Germany), 7 g of vinyltriethoxysilane (commercially available under the GENIOSIL® GF 56 name from Wacker Chemie AG, Munich, Germany) and 3.3 g of the hydrolyzate (S2) was mixed in a planetary mixer for a period of 30 minutes. Subsequently, 45 g of a fumed silica having a specific BET surface area of 150 m²/g (commercially available under the HDK® V15 name from Wacker Chemie AG, Munich, Germany) was mixed in and fully homogenized at a pressure of 50 hPa. Lastly, 2.5 g of zinc(II) octoate was added and the mixture was homogenized once again at a pressure of about 50 hPa (absolute) for 5 min.

The RTV1 composition thus obtained was dispensed into moisture-tight conventional polyurethane cartridges.

### Example 5

The mixtures produced in the examples and comparative example were each spread out onto a polyethylene film to create sheets of thickness 2 mm, which were detached from the film after curing for one day and suspended so as to enable exposure to air from all sides for a further 6 days, such that the samples were cured over a total of 7 days. Relative humidity was adjusted to 50%, and the temperature was kept at a controlled level of 23° C. Specimens of the S2 form according to ISO 37:2017 were then punched out of these sheets, and the respective modulus (stress value at 100% elongation of a specimen to ISO 37 S2) was ascertained.

The indices ascertained are listed in table 1.

All samples cured to give tack-free, elastomeric materials.

TABLE 1

| | Skin time | Yield point | Modulus |
|---|---|---|---|
| Example | (min) | (Pa) | (MPa) |
| V1 | 41 | 722 | 0.35 |
| 1 | 22 | 922 | 0.38 |
| 2 | 22 | 820 | 0.51 |
| 3 | 21 | 901 | 0.42 |
| 4 | 23 | 842 | 0.52 |

Surprisingly, inventive examples 1 to 4 have the desired small reduction in hardness values. This means that the elastomeric properties were maintained under the storage conditions specified.

1-10. (canceled)

11. A composition crosslinkable by condensation reaction, comprising:
(A) organosilicon compounds having at least two OH groups;
(B) heterocyclic compounds of the formula (I)
A[CR¹₂SiRₐ(OR²)₃₋ₐ]ₓ (I),
wherein A represents a radical based on a heterocycle AHₓ and containing at least one ring-forming element of main group 3 and/or 5, in which x hydrogen atoms are replaced by chemical bonds to the CR¹₂ radical, where at least one of these bonds is present on a ring-forming element of main group 3 or 5,
wherein R denotes identical or different, monovalent, optionally substituted hydrocarbyl radicals,
wherein R¹ may be the same or different and denotes a hydrogen atom or monovalent, optionally substituted hydrocarbyl radicals,
wherein R² may be the same or different and denotes monovalent, optionally substituted hydrocarbyl radicals;
wherein a=0 or 1,
wherein x=1, 2 or 3, and/or
partial hydrolyzates thereof;
(C) at least one compound containing units of the formulae
Si(OR⁴)₃O_{1/2} (III),
Si(OR⁴)₂O_{2/2} (IV),
(OR⁴)SiO_{3/2} (V), and
optionally SiO_{4/2} (VI),
wherein R⁴ may be the same or different and is in each case independently an alkyl radical; and
wherein with the compound (C) contains at least 10 mol % of units of the formula (V).

12. The composition of claim 11, wherein the organosilicon compounds (A) are those containing units of the formula (II)
R³_{b}(OH)_{c}SiO_{(4-b-c)/2} (II),
wherein R³ may be the same or different and denotes optionally substituted hydrocarbyl radicals that may be interrupted by oxygen atoms,
wherein b is 0, 1, 2 or 3, and
wherein c is 0, 1, 2 or 3; and
wherein the sum of b+c≤3 and at least two condensable OH radicals are present per molecule.

13. The composition of claim 11, wherein the compounds (C) contain units of the formulae (III), (IV) and (V) in total amounts of at least 70 mol %.

14. The composition of claim 11, wherein the compounds (C) contain 10 to 50 mol % of units of the formula (V), 15 to 60 mol % of units of the formula (III) and 20 to 60 mol % of units of the formula (IV).

15. The composition of claim 11, wherein the compounds (C) consist of units of the formula (III), (IV) and (V) and optionally (VI).

16. The composition of claim 11, wherein the composition comprises the component (C) in amounts of 1 to 20 parts by weight, based on 100 parts by weight of the component (A).

17. The composition of claim 11, wherein the composition comprises
(A) organosilicon compounds containing units of the formula (II);
(B) compounds of the formula (I);
(C) compounds containing units of the formulae (III), (IV) and (V) in total amounts of at least 80 mol %, with the proviso that they include at least 10 mol % of units of the formula (V);
optionally (D) catalysts;
optionally (E) compounds containing basic nitrogen;
optionally (F) fillers;
optionally (G) adhesion promoters;
optionally (H) plasticizers;
optionally (J) further crosslinkers;
optionally (K) additives; and
optionally (L) solvents.

18. The composition of claim 11, wherein the catalyst (D) comprises alkoxides of metals of the fourth transition group of the Periodic Table of the Elements, carboxylates of metals of the twelfth transition group of the Periodic Table of the Elements, and phosphonic esters.

19, The composition of claim 11, wherein the crosslinkable composition is a shaped body

20. A process for producing a crosslinkable composition, comprising:
providing
(A) organosilicon compounds having at least two OH groups,
(B) heterocyclic compounds of the formula (I)
A[CR¹₂SiRₐ(OR²)₃₋ₐ]ₓ (I),
wherein A represents a radical based on a heterocycle AHₓ and containing at least one ring-forming element of main group 3 and/or 5, in which x hydrogen atoms are replaced by chemical bonds to the CR¹₂ radical, where at least one of these bonds is present on a ring-forming element of main group 3 or 5,
wherein R denotes identical or different, monovalent, optionally substituted hydrocarbyl radicals,
wherein R¹ may be the same or different and denotes a hydrogen atom or monovalent, optionally substituted hydrocarbyl radicals,
wherein R² may be the same or different and denotes monovalent, optionally substituted hydrocarbyl radicals,
wherein a=0 or 1,
wherein x=1, 2 or 3, and/or
partial hydrolyzates thereof, and
(C) at least one compound containing units of the formulae
Si(OR⁴)₃O_{1/2} (III),
Si(OR⁴)₂O_{2/2} (IV),
(OR⁴)SiO_{3/2} (V), and
optionally SiO_{4/2} (VI),
wherein R⁴ may be the same or different and is in each case independently an alkyl radical, and
wherein with the compound (C) contains at least 10 mol % of units of the formula (V); and
mixing the individual components in any sequence.

21. The process of claim 20, further comprising forming a shaped body.
